(19) United States
(12) Patent Application Publication
(10) Pub. No.: US 2012/0090147 A1
(43) Pub. Date: Apr. 19, 2012

(54) PRECAST ELEMENT CONNECTOR AND CONNECTION METHOD

(75) Inventor: Richard Paul, Parkdale (AU)

(73) Assignee: SAFEPANEL PTY LTD, Parkdale (AU)

(21) Appl. No.: 13/142,894

(22) PCT Filed: Jul. 9, 2010
(86) PCT No.: PCT/AU10/00875

§ 371 Date: Oct. 25, 2011

(30) Foreign Application Priority Data
Jul. 9, 2009 (AU) 2009903210

(51) Int. Cl. F16B 17/00; B23P 17/04

(52) U.S. Cl. 29/428; 403/345

(57) ABSTRACT

A connection arrangement for connecting precast elements. The arrangement including a first member and a second member each for partial embedding in first and second precast elements respectively. The first and second members are connectable together to connect the first and second precast elements. The first member has a portion for embedding in the first element, while the second member has a first portion for embedding in the second element. The first portion of each of the first and second members extend to respective second portions and the second portions of each of the first and second members are arranged for mating connection.

### FIELD OF THE INVENTION

The present invention relates to a connector for connecting precast elements and a method for connecting such elements. The present invention also relates to individual precast elements and an assembly of connected precast elements, each of which employ a connector according to the invention. It will be convenient to describe the invention as it relates the connection of precast concrete building panels for constructing commercial buildings, however it is to be appreciated that the invention can be employed in the connection of other precast elements, such as concrete barriers, beams, columns and culverts.

### BACKGROUND OF THE INVENTION

A reference herein to matter which is given as prior art is not to be taken as an admission that the matter was part of the common general knowledge as at the priority date of any of the claims.

Precast concrete panels are used in the construction industry for the construction of buildings such as single and multi storey office buildings, retail outlets and warehouses. The concrete panels usually are cast in a precast factory or on site, left to cure and lifted into position by crane. For lifting the panels into position, the panels are cast with suitable anchors or connectors, for engagement by a crane. Once the panels have been lifted into position, they are stabilised in that position, at least partly through connection by suitable connectors that bridge facing side edges of the panels. In this way, the panels are fixed to each other.

For connecting panels together once they have been lifted into position, the panels can be cast to include connection plates adjacent front edges of the panels. Those connection plates can include one or more ferrules which extend into the panel and into which bolts can be fixed. The plates are positioned so that they are aligned adjacent to each other when two panels have been lifted into position. With the panels in position, a joining plate can be bolted to the connection plates to bridge between two panels and to connect them together. The joining plate is usually thereafter welded to the connection plates to ensure the integrity of the connection to the connection plates.

The use of the connection plates and joining plates as described above provides secure connection between adjacent panels. However, the method used to deploy the connection and joining plates is time consuming and expensive, and exposes the construction personnel to risk associated with the instability of the panels prior to them being properly secured against collapse. That is, while the panels are being secured together against collapse, there is a risk that they will collapse. That risk is only reduced or eliminated once the connection between the panels has been established.

The cost associated with the use of the connection and joining plates discussed above includes the cost of the plates themselves, along with the cost of the joining and welding operation. That operation requires a construction worker to bolt the joining plates to the connecting plates and then a welder with industry welding qualifications to weld the joining plates to the connecting plates. The construction worker and the welder might be the same person. That operation further requires appropriate scaffolding or the use of lifting equipment suitable to position the construction worker and welder at the location at which he or she can perform the joining and welding operation. It will be appreciated that most buildings will comprise a large amount of panels, so the welding operation can impose significant time and cost constraints and require significant attention to safety.

The present invention proposes a connection arrangement which Applicant expects will provide advantages in comparison to the prior art apparatus and methods discussed above.

### SUMMARY OF THE INVENTION

According to the present invention there is provided a connection arrangement for connecting precast elements, the connection arrangement including a first member for partial embedding in a first precast element and a second member for partial embedding in a second precast element, the first and second members being connectable together to connect the first and second precast elements together, the first member having a first portion for embedding in the first precast element and the second member having a first portion for embedding in the second precast element, the first portion of each of the first and second members extending to a second portion and the second portions of each of the first and second members being arranged for mating connection.

An advantage provided by the present invention, is that the first and second members are constructed to mate together, so connecting a pair of precast elements without requiring further bolting or welding as described in relation to the prior art above. In relation to precast concrete building panels, this presents an advantage that the panels can be securely connected together without installation personnel being placed in a position of risk in order to secure the panels in position. Rather, the panels can be secured in position with all installation personnel at a safe distance, given that the connection between adjacent panels can be made during positioning of the panels adjacent to each other by crane.

Applicant expects there to be cost savings provided by the elimination of a need for bolting and welding the connection arrangement of the present invention. In addition, Applicant expects there to be cost savings provided by a reduction in the number and size of the components of the connection arrangement of the present invention.

In some embodiments of the invention, a second portion of the first member can include an opening for receipt of the second portion of the second member. The arrangement can be such that upon at least partial insertion of the second portion of the second member through the opening of the first member, that second portion can be captured and the connection between the first and second members made or established. It will be appreciated that by this arrangement, a very fast and efficient connection between adjacent precast elements can be made.

The opening of the second portion of the first member can be a slot, which includes a first section for insertion of the second portion of the second member and a second section for capture of that second portion. In this arrangement, the slot can be open at one end for insertion of the second portion of the second member and capture of the second portion of the second member occurs following movement of that second portion within the slot away from the open end. The slot opening can be tapered so that the open end of the slot is wide and narrows in a direction inboard of the open end. This arrangement facilitates ease of insertion of the second portion of the second member into the slot. The tapered section of the slot can extend to a parallel sided section within which the second portion of the second member is captured when moved into that section.

Alternatively, the opening of the second portion of the first member can comprise a tapered slot which has a wide open end and tapers inboard of the open end and the second portion of the second member is captured at the narrow end of the slot.

The first portion of the first member can comprise one or more elongate members that extend from the second portion of the first member, such as the edge of the second portion. In some arrangements, a pair of elongate members is provided, and in other arrangements, three or four elongate members are provided. The security of embedding the first member in the precast element can be improved by increasing the number of elongate members, and therefore a greater number than four elongate members can be provided as required.

The elongate members can comprise a first elongate portion that extends from the second portion of the first member and a second transverse portion that extends transverse to the first elongate portion. That transverse portion can extend from any part of the first elongate portion, and in some arrangements, the transverse portion extends from an end of the elongate portion which is remote from the second portion of the first member. The transverse portion can extend at any suitable angle to the first elongate portion, and in some arrangements, the transverse portion extends generally perpendicular to the elongate portion.

In relation to the second member, the second portion of that member can comprise a head portion, or a head portion and a neck portion. In that arrangement, the neck portion is positioned between the head portion and the first portion of the second member which is embedded into a precast element. The head portion has a greater diameter than the neck portion. The second member can be formed as a pin, which has a head portion and a neck portion coaxial with the first portion of the second member. A body portion can be interposed between the first portion and the neck portion which has a greater diameter than the neck portion. Thus, the neck portion is interposed between head and body portions of greater diameter.

The second portion of the second member can include a deformable element, such as a deformable collar or the like, which deforms upon mating connection between the respective second portions of each of the first and second members. By this arrangement, the integrity of the connection between the first and second members can potentially be improved. In the above arrangement, in which the second portion of the second member comprises a head portion and a neck portion, a deformable collar can be positioned about the neck portion and can be arranged so that as the neck portion is captured by the second portion of the first member, the collar deforms, preferably in a manner such as to increase the frictional connection between the first and second members.

In some arrangements, the first portion of the second member is threaded, so that it can be threaded into a threaded ferrule which is cast into the second precast element. In other arrangements, the first portion of the second member can include one or more transverse flanges or projections, which assist anchoring the first portion within the precast element. In either arrangement, the first portion of the second member is embedded in the second precast member. Other arrangements for embedding the first portion in the second precast member can be employed.

It is to be noted that the first portion of the first member can be embedded only partially rather than fully. That applies to the first portion of the second member as well.

The mating connection between the first and second members can include a grout or resin component, which is either applied after the first and second members are matingly connected, or while that mating connection takes place. Thus, the grout or resin can be applied manually or automatically after the first and second members have been connected together, or the application of the grout or resin may occur automatically as the first and second members matingly connect.

In some forms of the invention, a rupturable package of grout or resin can be employed. The package can be formed and located so that as the second portion of the second member enters into mating engagement with the first member, the package is ruptured, spilling or releasing the grout or resin contents.

In order to rupture the package, the second member can be configured suitably, so that rupture takes place once mating connection between the first and second members is complete. Alternatively rupture can take place during mating connection but prior to that connection being completed. The rupturable package can be a flexible package or a rigid package, either of which can rupture. In one form of package, the package can be included as the precast element is formed and can be filled with grout or resin later. In one form, the rupturable package is removed from the precast element prior to connecting two precast elements together, is filled with a suitable amount of grout and reinserted into the precast element, so that as the two precast elements are connected together, the package is ruptured to release the grout or resin.

The first member can be configured to define an appropriate pocket or void into which the grout or resin can flow and into which a portion of the second member will reside upon mating connection, so that that portion of the second member is immersed in the grout or resin and the grout or resin sets about that portion. That void might be at least partly formed by the precast element into which the first member is embedded and in some forms the first precast element can include a recess into which the first member is accommodated and that recess can be configured to at least partly accommodate a grout or resin package also.

The grout or resin package can be applied just prior to the first and second members being brought into mating connection, or the package could be attached to or formed as part of the first member, or attached to or as part of the second member, and could be present when the respective first or second member is embedded in the first precast element, or after embedding has taken place. These latter arrangements can be employed with a two-part epoxy resin, in which the respective parts of the resin can be kept separate until the package is ruptured by mating connection of the first and second members. Thereafter, the two parts of the epoxy resin can mix and cure.

Alternatively, the grout or resin can be added to an empty package which is formed as part of a precast element, when the first and second members of adjacent precast elements are to be brought into mating connection. The package can be a flexible or rigid package.

An alternative to a package, is to apply a grout or resin to the first and second members once mating connection has been made. This application could be made remotely, such as by installation personnel, who could direct a suitable application tube or hose or the like in order to apply the grout or resin.

The present invention also provides a precast element assembly, the assembly including first and second precast elements and a connection arrangement for connecting the first and second precast elements together, the connection arrangement including first and second members each having first and second portions, the first portion of the first member being embedded in the first precast element and the first portion of the second member being embedded in the second precast element, the second portions of the first and second members being connected to the respective first portions of the first and second members and the second portions of the respective first and second members being in mating connection with each other.

A precast element assembly according to the invention can include a connection arrangement of the kind described above. Accordingly, in some arrangements, a precast element assembly includes a first member in which the second portion includes an opening through which the second portion of the second member can extend and can be captured against release. In this arrangement, the opening of the second portion of the first member can be a slot which has an open end into which the second portion of the second member can be inserted. The slot can taper from the open end to narrow in a direction away from the open end. The slot can include first and second sections. The first section of the slot can be for insertion of the second portion of the second member, while the second section of the slot can be for capture of the second portion of the second member.

Likewise, in some forms of the precast element assembly, the first portion of the first member can comprise one or more elongate members that extend from the second portion of the first member and into the precast element. It is to be noted that the first portion of the first member is embedded in the precast element, but that does not require complete embedding of the first portion. Rather, a section of the first portion can extend out of the precast element for connection to the second portion of that member and still constitute embedding in the precast element. That applies to the first portion of the second member as well.

The first precast element can include a recess within which the first member is at least partially accommodated. In some arrangements, the second portion of the first member includes a generally planar face and that face is generally flush with the portions of the first precast element which surround the recess. The accommodation of the first member within a recess in the first precast element enables adjacent elements to sit flush against each other, without impediment from the first and second members.

The recess described above can have a greater extent than just to accommodate the first member. This allows the second portion of the second member to be inserted into the recess, prior to that member being matingly connected to the first member.

Thus, the method of connection can be that the second portion of the second member is inserted into the recess, and thereafter the second member is shifted to mate with the first member, the shifting movement taking place within the recess.

The recess referred to above can also accommodate a grout or resin package, or can be arranged for receipt of grout or resin as described earlier, in order to anchor the second portion of the second member relative to the second portion of the first member. Any suitable arrangement for this can be adopted, while the arrangement can be such that both the first member and the recess cooperate to form a void or the like to accommodate the grout or resin, either in an injected form following connection between the first and second members, or in a package form, which is inserted prior to mating connection between the first and second members.

It will be appreciated from the above discussion, that the invention has particular application to precast concrete building panels. Accordingly, in a precast element assembly according to the invention, the first and second precast elements can be precast concrete building panels. In that arrangement, the first portions of the first and second members can be embedded in side edges of the panels for edge to edge connection between the panels.

The present invention still further provides a method of connecting precast elements together, including forming a first precast element with a first connecting member at least partly embedded therein and forming a second precast member with a second connecting member at least partly embedded therein, positioning the first precast member in position, positioning the second precast member by shifting the second precast member relative to the first precast member so that the first connecting member of the first precast member mates with the second connecting member second precast member.

In the method according to the invention, the shifting movement of the second precast member relative to the first precast member can include a first movement in which the first and second members are aligned for mating connection and a second movement in which the first and second members actually mate together. To facilitate this method, the first connecting member can include a slot which has a first section for insertion of a portion of the second connecting member and a second section for capture of the portion of the second member. In this arrangement, the first and second members mate together when the portion of the second member is captured within the second section of the slot of the first member. The first and second sections of the slot can be sections of different profile, such as a tapered section that extends to a parallel sided section as described above. Alternatively, the first and second sections of the slot can be sections of the same or similar profile, such that the open region of a tapered section can constitute the first section and the region remote from the open region can constitute the second section.

The movement in the method of the invention can comprise lowering of the second precast member relative to the first precast member. In relation to precast concrete building panels, the first concrete panel would first be positioned in place and supported, and thereafter the second panel would be aligned with the first panel, but raised to a greater height than the first panel, and thereafter, the second panel would be lowered relative to the first panel in a manner which causes mating engagement between the first and second members. As described above, at least the first precast panel can include a recess to accommodate the first connecting member and in the method of the invention, the second connecting member can be at least partially moved into the recess prior to mating with the first connecting member.

The present invention also extends to a precast element, which includes first and second members embedded therein. In particular, the invention extends to a precast concrete building panel, in which a first member is embedded in a side edge of the panel and a second member is embedded in the opposite side edge.

### BRIEF DESCRIPTION OF THE DRAWINGS

For a better understanding of the invention and to show how it may be performed, embodiments thereof will now be described, by way of non-limiting example only, with reference to the accompanying drawings.

FIG. 1 is a perspective view of a connection arrangement in a disconnected state according to one embodiment of the invention.

FIG. 2 is a perspective view of the connection arrangement of FIG. 1 in a connected state.

FIGS. 3 to 5 are cross-sectional views of part of a pair of precast concrete panels employing a connection arrangement according to the invention and showing the arrangement moving from a disconnected to a connected state.

FIG. 6 is the view of FIG. 5 with a grout or resin injected to assist to secure the connection arrangement in place.

FIG. 7 is an exploded view of components of a connection arrangement according to the invention.

FIG. 8 is an assembled view of the components of FIG. 7.

FIG. 9 is a further assembled view of the components of FIG. 7.

FIG. 10 is a view of the assembly of FIG. 8, with an insert part being removed.

FIG. 11 is a perspective view of a precast concrete panel showing one part of a connection arrangement according to the invention and installed in an edge of the panel.

FIG. 12 is a perspective view of a pair of precast concrete panels being shifted into a connecting engagement.

FIG. 13 is a perspective view of a plurality of precast concrete panels connected with connection arrangements according to the invention.

### DETAILED DESCRIPTION OF THE DRAWINGS

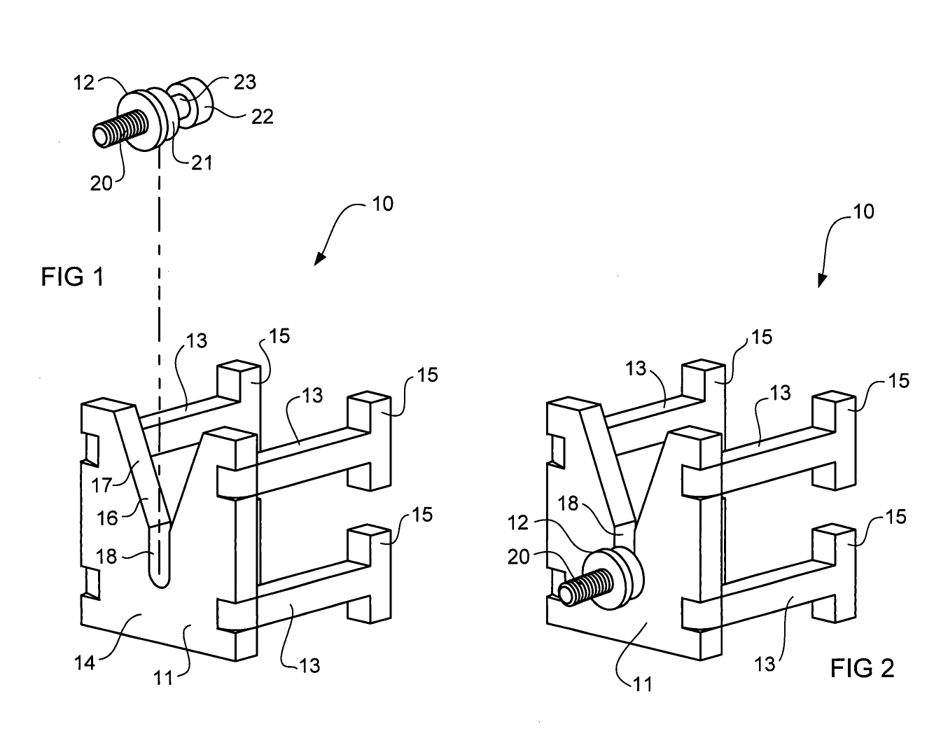

FIG. 1 illustrates a perspective view of a connection arrangement 10 according to one embodiment of the invention. The connection arrangement 10 is shown as comprising a first member 11 and a second member 12 and in the illustration shown in FIG. 1, the second member 12 is displaced from the first member 11, ready for connection to the first member 11.

The first member 11 includes a first portion which comprises four elongate members 13 (only three of which are visible in FIG. 1) which are connected to and extend from a second portion 14. Each of the elongate members 13 extends rearwardly from the second portion 14 and at the ends of the members 13 remote from the second portion 14, each elongate member 13 includes a transverse portion 15, which extends generally perpendicular to the elongate member 13 to which it is connected.

The elongate members 13, the second portion 14 and the transverse portions 15 are stamped from a single piece of sheet metal, and are formed into the shape shown by pressing or stamping. An alternative is to assemble the elongate members 13 to the second portion 14 by welding, but that is expected to add additional cost.

The second portion 14 includes an open ended slot 16. The slot 16 includes a tapered section 17 and a parallel sided section 18.

The second member 12 includes a first portion which comprises a threaded shank 20, and a second portion which comprises a body 21, a neck 22 and a head 23. The body and head 21, 23 have a greater diameter than the neck 22.

With reference to FIG. 2, this shows the second member 12 in mating connection with the first member 11. As will be apparent, the neck 22 is received within the parallel sided section 18 of the slot 16, while the body 21 and the head 23 sit on either side of the section 18. The head 23 thus engages against the rear surface (not visible in FIG. 2), of the second portion 14 of the first member 11 and prevents withdrawal of the second member 12 from the first member 11.

As discussed previously, the second portion of the second member can include a deformable element, such as a deformable collar and in the second member 12, that collar (not shown) can be disposed around the neck 22, between the body 21 and the head 23. The collar would be undeformed in the position of the second member shown in FIG. 1, and would be deformed in the position shown in FIG. 2, in which the neck 22 is received within the parallel sided section 18 of the slot 16. The provision of a deformable collar increases the level of engagement between the first and second members 11 and 12 in the matingly connected condition as shown in FIG. 2.

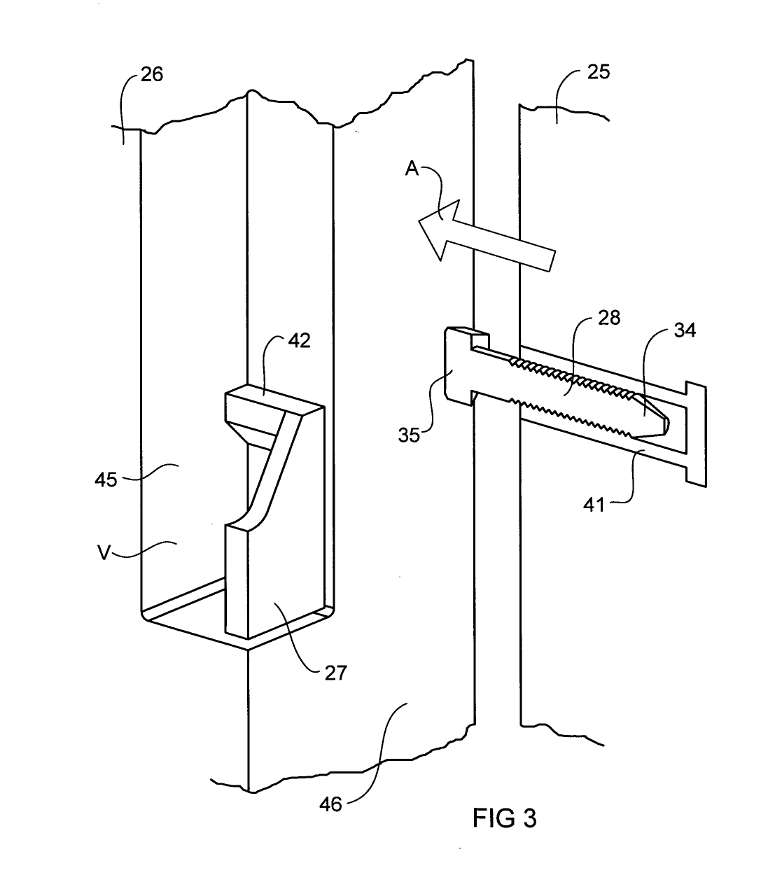

With reference to FIGS. 3 to 6, these show a pair of precast elements 25 and 26, to which have been fitted respective first and second members 27 and 28 (shown in cross-section). For the purposes of this discussion, the elements 25 and 26 can be considered to be precast concrete building panels, which are to be connected together edge to edge.

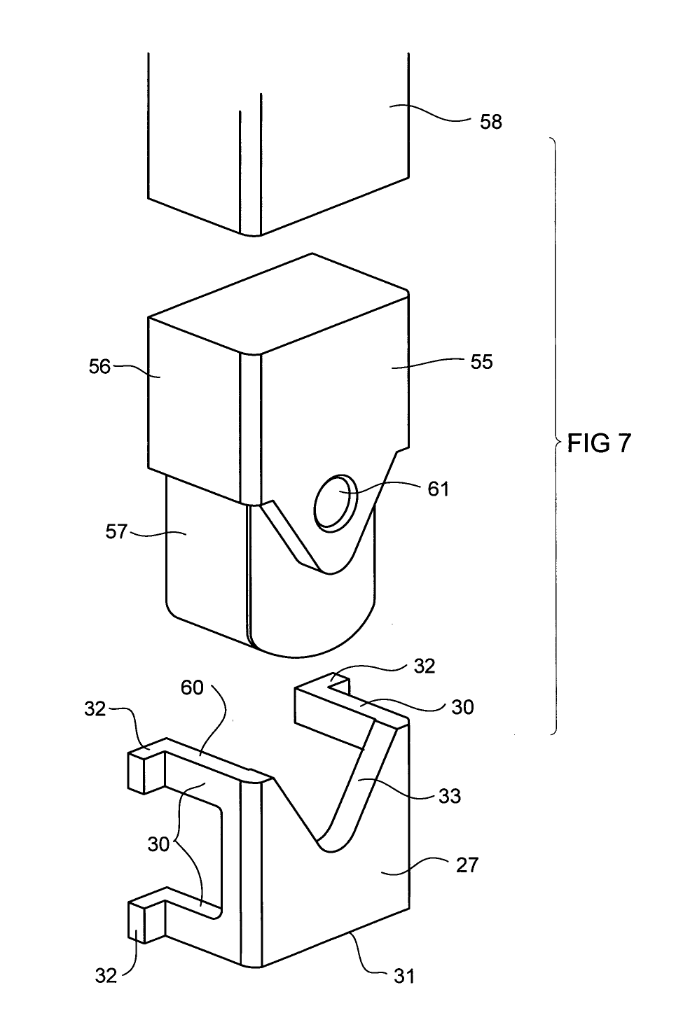

The first and second members 27 and 28 have a different form to that of the first and second members 11 and 12. The first member 27 is shown in full perspective view in FIG. 7 and referring to that figure, the member 27 includes a first portion which comprises four elongate members 30 (only three of which are visible in FIG. 7) which are connected to and extend from a second portion 31. Each of the elongate members 30 extends rearwardly from the second portion 31 and at the ends of the members 30 remote from the second portion 31, each elongate member 30 includes a transverse portion 32, which extends generally perpendicular to the elongate member 30 to which it is connected.

The elongate members 30, the second portion 31 and the transverse portions 32 are stamped from a single piece of sheet metal, and are formed into the shape shown by pressing or stamping.

The second portion 31 includes an open ended slot 33 which is tapered.

Referring back to FIGS. 2 to 6, the second member 28 includes a first portion which comprises a threaded shank 34 and a head 35. The head 35 has a greater diameter than the threaded shank 34.

Referring first to the second member 28, that member is embedded in the element 25 by a threaded connection through the edge 40 of the element 25 to an internally threaded ferrule 41, which is precast into the element 25. In order to thread the second member 28 into the ferrule 41, the head 35 of the member 28 can be formed hexagonal (as shown) or square, for tightening by a suitable tool.

The first member 27 has the elongate members 30 thereof and the transverse portions 32 embedded within the element 26. The elongate members 30 are not completely embedded within the element 26, but a forward portion 42 of those elements projects out of the element 26. Those portions 42 and the second portion 31 are accommodated within a recess 45 which is formed in the edge 46 of the element 26. FIG. 3 illustrates that the forward most portion of the second portion 31 is slightly inboard of flush with the edge 46 of the element 26. In practice, it will be appreciated that there can be some deviation from the position shown. Thus, the front face of the second portion 31 may sit slightly proud of, or slightly inboard of the edge 46.

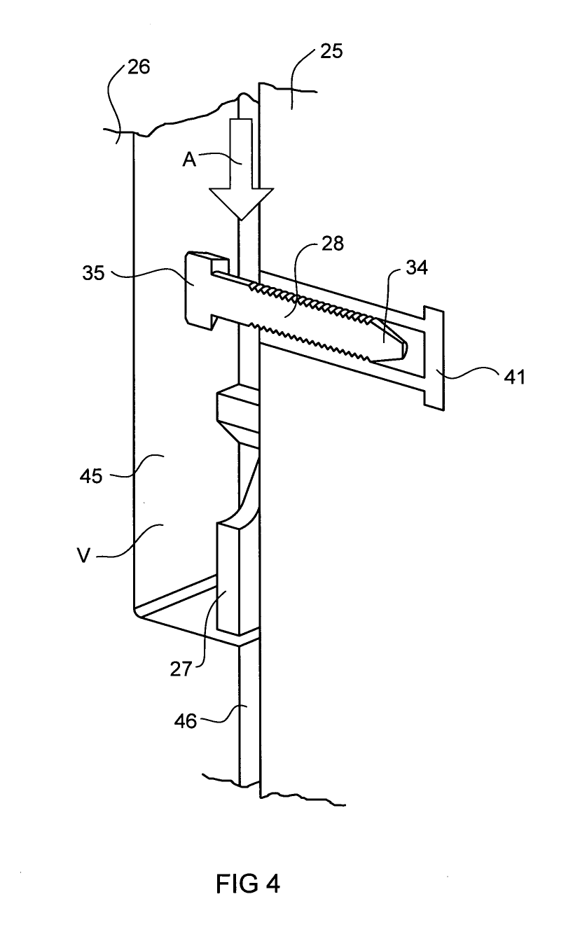

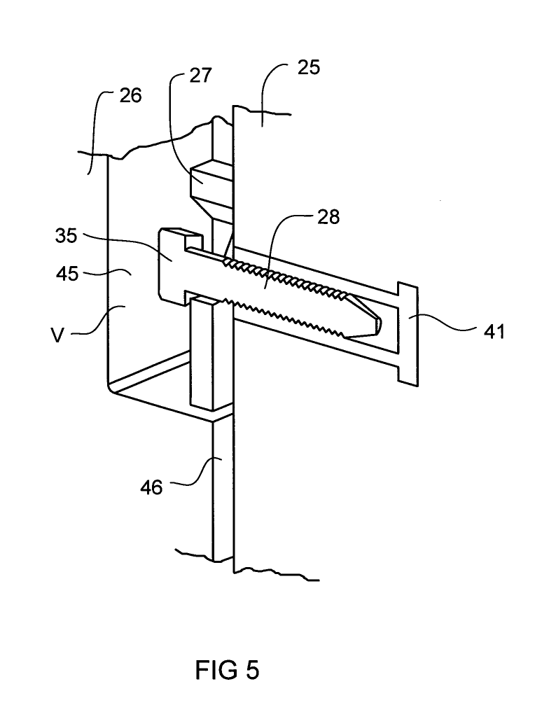

Arrow A in FIG. 4 illustrates that the second member 28 is to be lowered for mating connection with the first member 27. Thus, the second member 28 is shown in a similar position to the second member 12 of FIG. 1, in which it is above the first member 11, but ready for mating connection with the member 11. Accordingly, in order to cause mating engagement between the second member 28 and the first member 27, the element 25 is lowered in the direction of arrow A until the head 35 is received within the slot 33 (see FIG. 7) at the bottom end thereof and behind the second portion 31 as shown in FIG. 5. It will be appreciated, that once the head 35 is received in the position shown in FIG. 5, shifting movement of the element 25 away from the element 26 is prevented.

FIGS. 3 to 5 also illustrates void V, which is positioned between the second portion 31 of the first member 27 and the inner surface of the recess 45. The void V can accommodate a grout or resin package, which is ruptured as the head 35 of the second member 28 moves into the void V. Upon rupture, the grout or resin can flow about the head 35 to add to the integrity of the mating connection between the first and second members 27 and 28. FIG. 7 illustrates a suitable grout or resin package which will be described in more detail later herein.

In an alternative arrangement, a suitable grout or resin can be fed into the void V upon the first and second members 27 and 28 having been matingly engaged.

FIGS. 3 to 6 illustrates the elements 25 and 26 in perspective view, and shows the first member 27 in position within the recess 30 and the elongate members 30 are shown extending into an embedded position within the element 26 The second member 28 is also shown embedded within the element 25 within a ferrule 41. FIGS. 3 to 5 illustrate three relative positions of the elements 25 and 26 moving from a first position in which the second member 28 is outside of the recess 45, forwardly to a second position inserted into the recess 45 and finally downwardly into a third position in mating connection with the first member 27. It is this movement shown in FIGS. 3 to 5 that is anticipated to be appropriate for the connection of precast concrete building panels on-site. Therefore, the movement shown in FIGS. 3 to 5 is intended to be the movement that a precast concrete building panel, to which the present invention is being employed, would move, in order to connect the second member 28 to the first member 27. Advantageously, that movement can be made with the building panel supported by a crane, given that crane operators can, with significant precision, position one building panel next to the other. Thus, the illustrated movement is considered to be within the skill of crane operators which are employed in the construction industry.

Once the second member 28 has been matingly connected to the first member 27, it will be appreciated that movement of the element 25 away from the element 26 in the plane of the elements is resisted. It is considered that each of the first and second members 27 and 28 can be embedded to the extent that no reasonable load tending to shift the element 25 and 26 apart would dislodge the second member 28 from the first member 27. Thus, the expectation is that the mating connection between the first and second members 27 and 28 will securely connect the two elements together.

A significant safety advantage is provided as explained above, in that the connection between the members 27 and 28 can be made without requiring construction personnel to manipulate the elements by hand. This differs from the prior art which is discussed above, in which manual bolting and welding is a requirement.

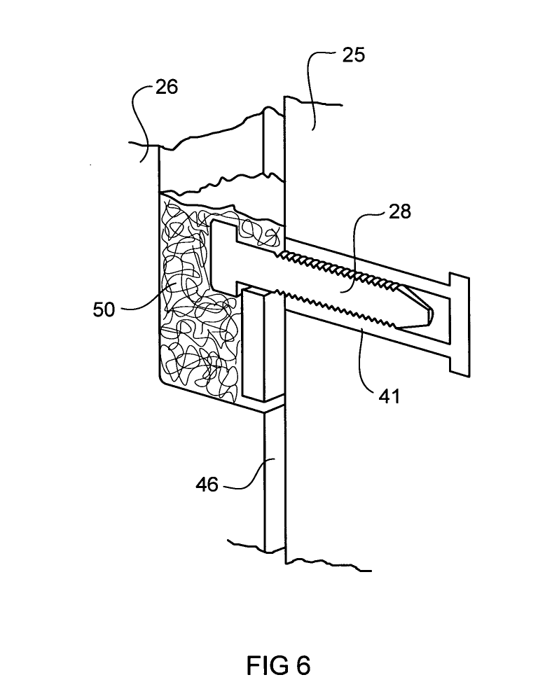

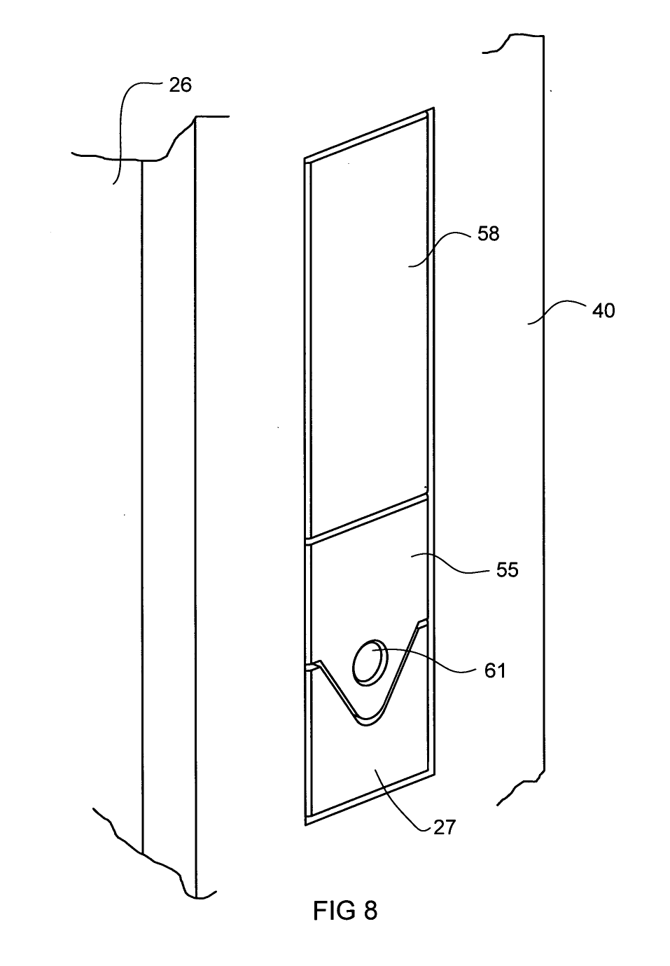

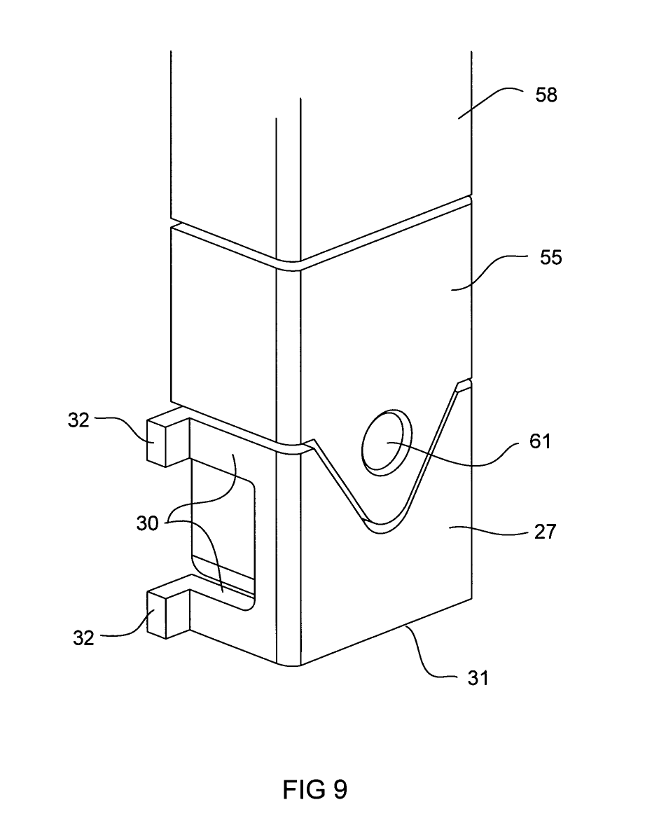

FIG. 6 shows the arrangement illustrated in FIG. 5, in which the first and second members 27 and 28 are in mating engagement, but FIG. 6 further shows a body of resin or grout 50 which has been injected into the Void of FIGS. 3 to 5. The resin or grout 50 can be injected in any suitable manner, but with reference to FIG. 7, in one form, the resin or grout can be positioned through the use of a hard plastic package or container which is shown in FIGS. 7 to 9. Referring to FIG. 7, the container 55 has an upper portion 56 and a lower portion 57. The lower portion 57 is shaped to nest within the Void formed by the first member 27 and this nesting arrangement is illustrated in FIGS. 8 and 9. FIG. 8 shows the arrangement applied to the edge 40 of the precast element 26 and comprises the first member 27, the container 55 and a polystyrene filler 58. The container 55 thus includes a step 59 at the junction between the upper and lower portions 56 and 57, which rests against the upper surface 60 of the first member 27 which extends along the upper elongate members 30 and the slot 33.

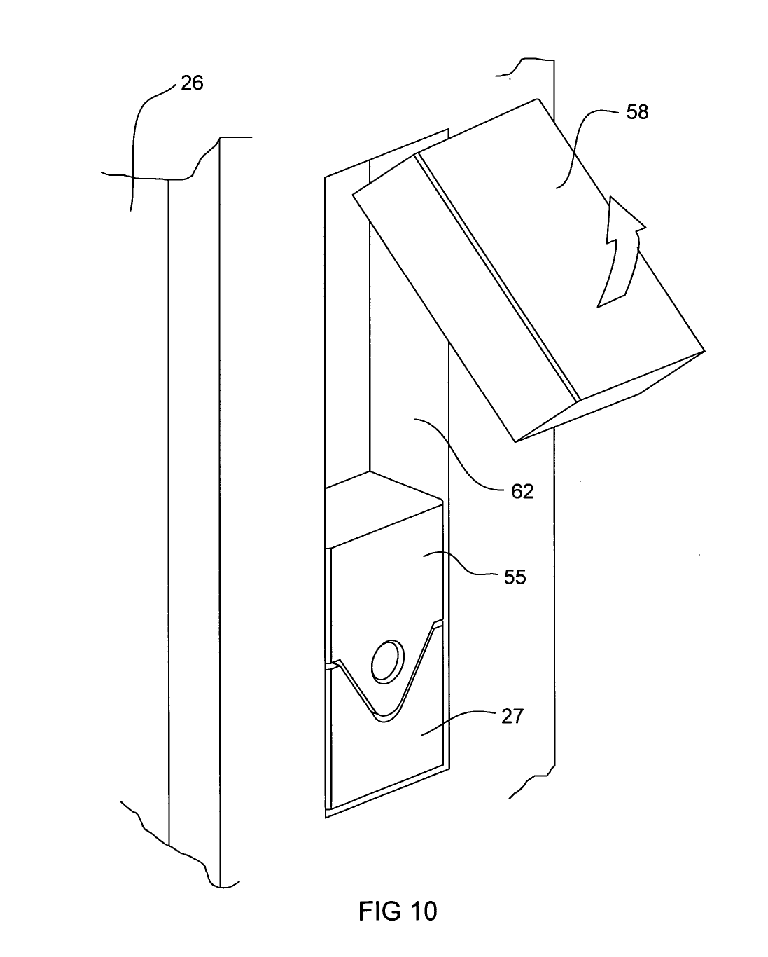

The container 55 includes an opening 61 and that opening is provided for the purpose of injecting resin or grout into the container 55 just prior to mating engagement between the respective first and second members 27 and 28. Thus, a precast element 26 would be formed having the arrangement shown in FIG. 8 formed along an edge 40 thereof, but the container 55 of that arrangement would be left empty. When two precast elements are ready to be assembled adjacent to one another, resin or grout can be inserted into the container 55 through the opening 61. At about the same time, the polystyrene filler 58 can be removed (as shown in FIG. 10) so that an upper portion 62 of the recess 45 is open for insertion of the second member 28 as shown in Figure ?. It is to be noted that FIGS. 3 to 5 shown an arrangement which does not include the container 55, but if the container 55 was to be included in the arrangement of FIGS. 3 to 5, it would be ruptured or shattered as the head 35 of the second member 28 enters the recess 45 and moves downwardly to engage within the slot 33. The container 55 is thus made of a material which shatters or ruptures under such an engagement.

The filler 58 is provided simply to form the recess 55 during casting of the element 26.

The filler 55 can thus be removed once the element 26 has been formed, or it can remain in place until just before the precast elements are to be assembled together. It is preferred that the filler 58 remain in place so as to retain the container 55 in the position as shown in FIG. 8.

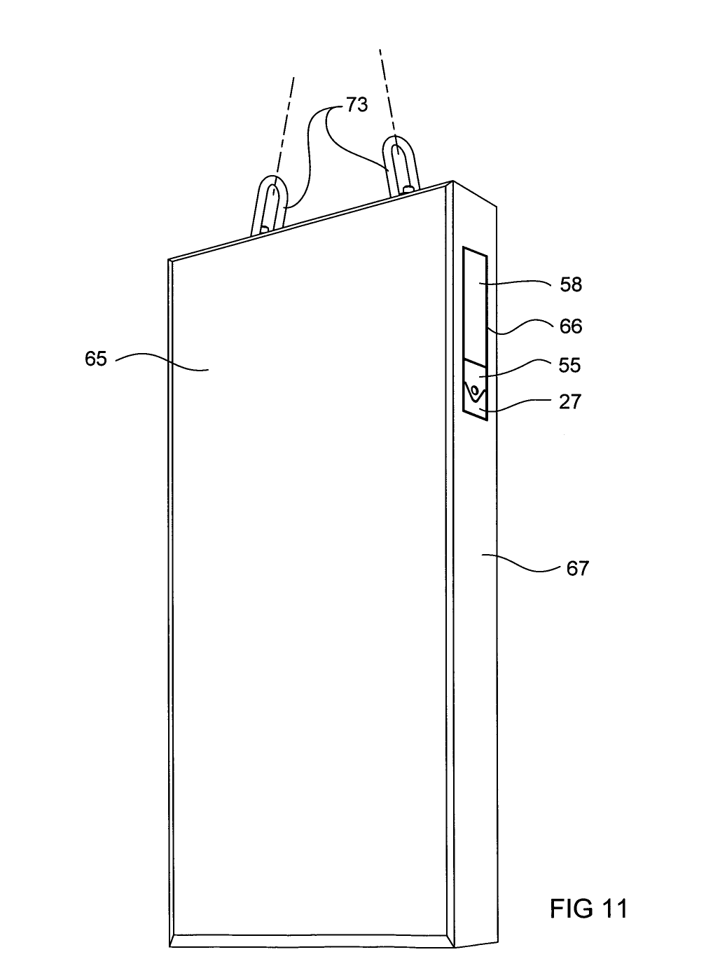

Referring now to FIGS. 11 to 13, FIG. 11 illustrates a precast concrete building panel 65 which includes an assembly 66 in an edge 67 thereof which is the same as the assembly illustrated in FIGS. 7 to 9. Thus, the assembly includes the filler 58, the container 55 and the first member 27.

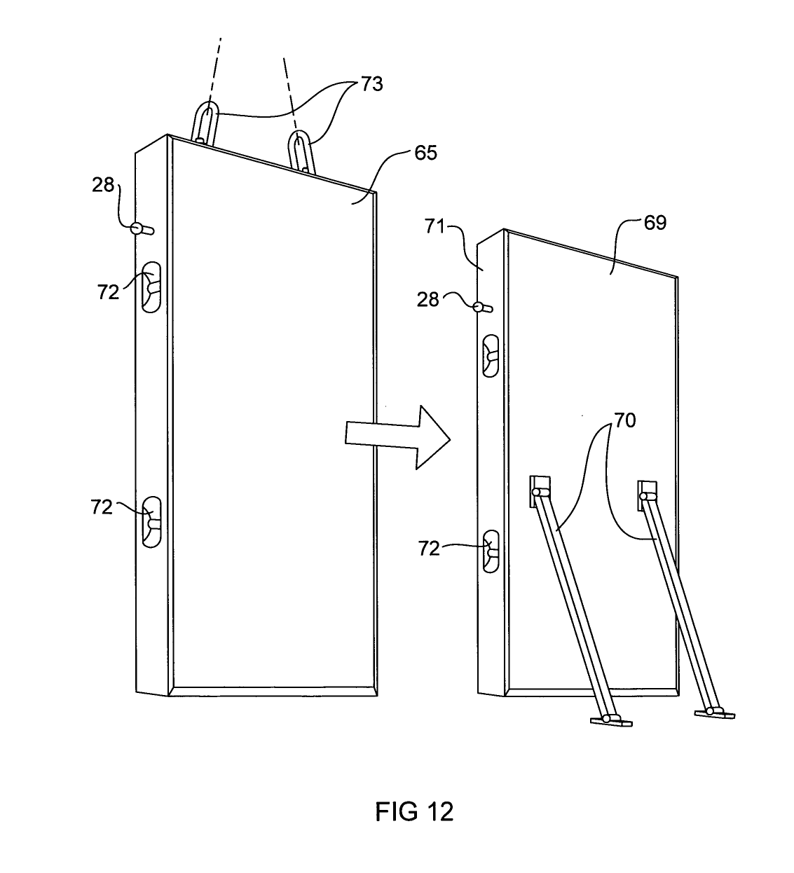

FIG. 12 shows a second precast concrete panel 69 which has been positioned in place and is supported in that position by struts 70. The panel 69 includes an edge 71 from which protrudes a second member 28. Thus, the panel 69 is equivalent to the precast element 25 of the earlier Figures. The edge 71 further includes lifting lugs 72 which are provided for lifting the panel 69 via a standard clutch and chain arrangement of the form as shown in FIG. 11 and identified by the numeral 73.

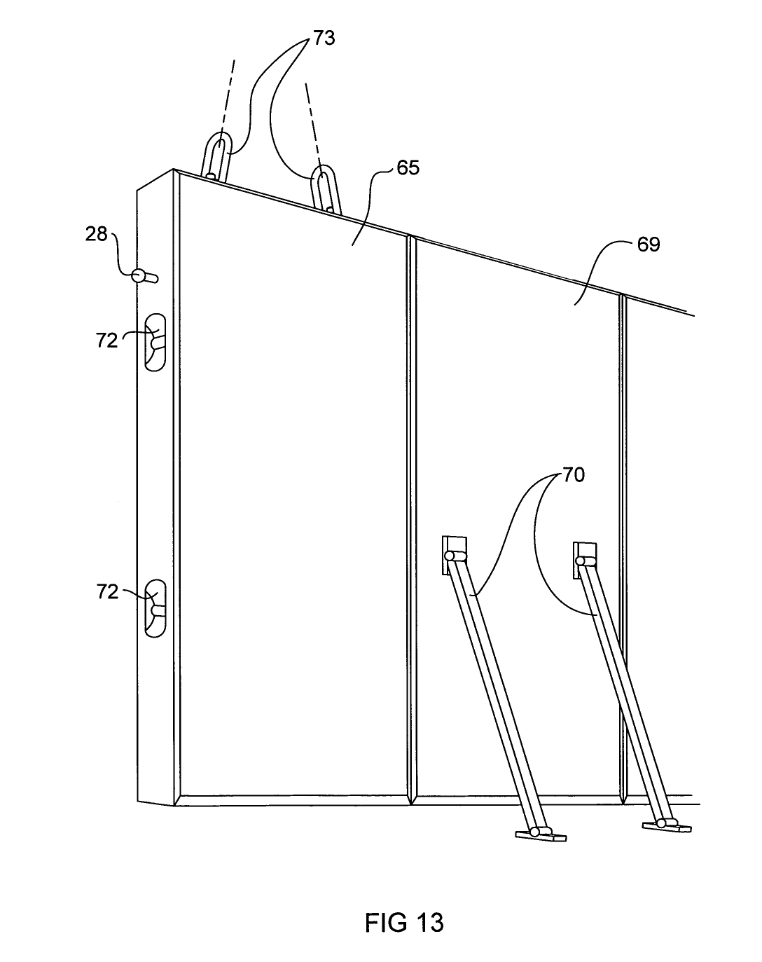

The panel 65 is shown in FIGS. 12 and 13 from an opposite perspective view so that that panel can been seen also to include a second member 28. Thus, it will be understood that various panels which adopt the arrangement of the present invention will have a first member 27 disposed on one edge, and a second member 28 disposed on the other edge.

In FIG. 12, the panel 65 is being lifted and moved towards the edge 71 of the panel 69. In FIG. 13, the panels 65 and 69 have been moved into engagement, whereby the second member 28 as being received within the first member 27. In the FIG. 11 illustration, the filler 58 is still connected, but just prior to engagement or assembly of the panels 65 and 69 together, the filler 58 is removed and grout or resin is injected into the container 55.

When the panels 65 and 69 are connected as shown in FIG. 13, further struts 70 can be applied to support the panel 65. With those struts applied, the panel 65 is securely positioned in connection with the panel 69 and without the necessity of the prior art arrangements requiring a bolting and welding. The arrangement of the invention is considered to be facilitated by the crane driver being able to properly position one precast panel adjacent the other in a manner to position the second member 28 within the first member 27. Thus, the panels can be assembled without construction personnel having to be in close vicinity to the panels to connect them together.

The process of positioning further panels can be repeated as explained above for the length of a building wall.

The invention described herein is susceptible to variations, modifications and/or additions other than those specifically described and it is to be understood that the invention includes all such variations, modifications and/or additions which fall within the spirit and scope of the above description.

1. A connection arrangement for connecting precast elements, the connection arrangement including a first member for partial embedding in a first precast element and a second member for partial embedding in a second precast element, the first and second members being connectable together to connect the first and second precast elements together, the first member having a first portion for embedding in the first precast element and the second member having a first portion for embedding in the second precast element, the first portion of each of the first and second members extending to a second portion and the second portions of each of the first and second members being arranged for mating connection.

2. A connection arrangement according to claim 1, the second portion of the first member including an opening and the second portion of the second member being formed for at least partial insertion through the opening and for capture by the second portion of the first member following insertion through the opening.

3. A connection arrangement according to claim 2, the opening of the second portion of the first member being a slot in which the slot includes a first section for insertion of the second portion of the second member and a second section for capture of the second portion of the second member.

4. (canceled)

5. A connection arrangement according to claim 3, the slot being open at one end for insertion of the second portion of the second member into the slot, the slot being tapered so that the open end of the slot is wide and narrows in a direction inboard of the open end and capture of the second portion of the second member occurring following movement of the second portion of the second member within the slot away from the open end.

6. (canceled)

7. A connection arrangement according to claim 1, the first portion of the first member comprising one or more elongate members that extend from the second portion of the first member.

8. (canceled)

9. (canceled)

10. A connection arrangement according to claim 7, one or more of the elongate members comprising a first elongate portion that extends from the second portion of the first member and a second transverse portion that extends transverse to the first elongate portion.

11. (canceled)

12. (canceled)

13. A connection arrangement according to 7, the second portion being substantially planar and extending in a first plane and the one or more elongate members extending substantially perpendicular to the second portion.

14. (canceled)

15. A connection arrangement according to claim 1, the second portion of the second member comprising a head portion and a neck portion, the neck portion being positioned between the head portion and the first portion of the second member, the head portion having a greater diameter than the neck portion.

16. (canceled)

17. (canceled)

18. A precast element assembly, the assembly including first and second precast elements and a connection arrangement for connecting the first and second precast elements together, the connection arrangement including first and second members each having first and second portions, the first portion of the first member being embedded in the first precast element and the first portion of the second member being embedded in the second precast element, the second portions of the first and second members being connected to the respective first portions of the first and second members and the second portions of the respective first and second members being in mating connection with each other.

19. (canceled)

20. (canceled)

21. (canceled)

22. (canceled)

23. (canceled)

24. A precast element assembly according to claim 18, the first precast element including a recess within which the first member is at least partially accommodated.

25. A precast element assembly according to claim 24, the recess having a length suitable to at least partly accommodate the second portion of the second member prior to mating connection between the second portions of the first and second members.

26. A precast element assembly according to claim 25, the recess extending above the first member when the first precast element is in an upright condition.

27. A precast element assembly according to claim 18, the first and second precast elements being precast concrete building panels and the first portions of the first and second members being embedded in side edges of the panels for edge to edge connection between the panels.

28. A method of connecting precast elements together, including forming a first precast element with a first connecting member and forming a second precast element with a second connecting member, positioning the first precast element in position, positioning the second precast element in position by shifting the second precast element relative to the first precast element so that the first connecting member of the first precast element mates with the second connecting member of the second precast element.

29. A method according to claim 28, the shifting movement of the second precast member relative to the first precast member including a first movement in which the first and second members are aligned for mating connection and a second movement in which the first and second members mate together.

30. A method according to claim 29, the first connecting member including a slot having a first section for insertion of a portion of the second connecting member and a second section for capture of the portion of the second member, whereby the first and second members mate together when the portion of the second member is captured by the second section of the slot of the first member.

31. (canceled)

32. A method according to claim 29, the second movement comprising lowering the second precast member relative to the first precast member and the first connecting member being at least partially accommodated within a recess and the second connecting member being at least partially moved into the recess prior to mating with the first connecting member.

33. A precast element including first and second connecting members embedded therein, the first connecting member being connectable to a second connecting member of a second precast element and the second connecting member being connectable to a first connecting member of a third precast element, the first and second connecting members each having a first portion embedded in the precast element and each having a second portion for mating connection to second portions of first and second connecting members of respective second and third precast elements.

34. A precast element according to claim 33, the element being a precast concrete building panel and the first portions of the first and second members being embedded in opposite side edges of the panel.

35. A precast element according to claim 34, the first member being accommodated at least partially within a recess formed in one of the side edges of the panel.

36. A precast element according to claim 33, the second portion of the first member including an opening for at least partial receipt of the second portion of a second member of a second precast element for capture of the second portion of the second member by the second portion of the first member.

37. (canceled)

38. (canceled)

39. (canceled)

40. (canceled)
